(19) United States
(12) Patent Application Publication
(10) Pub. No.: US 2024/0391113 A1
(43) Pub. Date: Nov. 28, 2024

(54) GRIPPING DEVICE WITH POSITION SENSOR

(71) Applicant: SCHUNK SE & Co. KG Spanntechnik Greiftechnik Automatisierungstechnik, Lauffen am Neckar (DE)

(72) Inventors: Julian Heinzl, Brackenheim (DE); Jonas Nägele, Öhringen/Möglingen (DE); Bruno Fellhauer, Brackenheim (DE); Florian May, Heilbronn (DE); Lutz Hausser, Bad Rappenau (DE)

(21) Appl. No.: 18/689,266

(22) PCT Filed: Jun. 30, 2022
(86) PCT No.: PCT/EP2022/068019

§ 371 Date: Mar. 5, 2024

(30) Foreign Application Priority Data
Sep. 6, 2021 (DE) 10 2021 122 975.8

(51) Int. Cl. B25J 15/02; B25J 13/08

(52) U.S. Cl. CPC B25J 15/0253; B25J 13/088

(57) ABSTRACT

The invention relates to a clamping or gripping device (10) comprising a housing (12), a clamping guide (14) which is arranged in the housing (12), at least one clamping element (18) which can be moved in the clamping guide (14) along a clamping direction (16), and at least one position sensor (64) for detecting the position of the clamping element (18). The invention is characterized in that at least one inclined measuring surface (54) is provided in or on at least one clamping element (18), wherein the inclined measuring surface (54) is arranged at an angle (α) of more than 0° and/or less than 90°, in particular between 1° and 40°, preferably between 2° and 15°, relative to the clamping direction (16), and the at least one position sensor (64) is designed such that the position sensor detects the position of the at least one clamping element (18) along the clamping guide (14) on the basis of the distance (A) between the at least one position sensor (64) and the at least one inclined measuring surface (54), said distance running perpendicularly to the clamping direction (16).

The invention relates to a clamping or gripping device for clamping or gripping components, comprising a clamping guide which is arranged in the housing, at least one clamping element which can be moved in the clamping guide along a clamping direction, and at least one position sensor for detecting the position of the clamping element.

DE102019103917A1 discloses a clamping or gripping device comprising a housing, a clamping guide which is arranged in the housing and designed as a multi-groove guide, and at least one clamping element which can be moved in the clamping guide along a clamping direction.

It is also known that position sensors are used for detecting the position of the clamping element. In this case, it is regularly necessary to configure the position sensor in a time-consuming manner at the start of operation in order to achieve a desired measurement accuracy. In addition, a plurality of position sensors are often required in order to provide a multi-position query, which goes beyond the detection of the state of the clamping element as “open” and “closed.”

The object of the invention is to provide a clamping or gripping device which comprises a position sensor and is advantageous in comparison to the known prior art, in particular requires little installation effort and enables continuous position detection of the clamping element.

This object is achieved by a clamping or gripping device having the features of claim 1. An inclined measuring surface is provided in or on the clamping element and is arranged at an angle of more than 0° and/or less than 90°, in particular between 1° and 40°, preferably between 2° and 15°, relative to the clamping direction. The position sensor is in particular provided in a stationary manner in or on the housing and is designed such that it detects the position of the clamping element on the basis of the distance between the position sensor and the inclined measuring surface, said distance running perpendicularly to the clamping direction.

By arranging the inclined measuring surface on the clamping element and detecting the position on the basis of the inclined measuring surface, continuous position detection of the clamping element along the clamping direction can be achieved by means of a position sensor. Furthermore, the position detection involves little installation effort due to the simple correlation between the detected distance and the position of the clamping element. In addition, high measurement and repeat accuracy can be achieved with the measuring arrangement in the position detection of the clamping element by carrying out the measurement of the position directly at the clamping element.

The clamping or gripping device is preferably designed as a parallel gripper with two gripping jaws as clamping elements, wherein a gripping finger can be arranged on each of the gripping jaws. Alternatively, the clamping or gripping device is designed as a clamping means with two parallel arranged clamping jaws or with three or more centrically arranged clamping jaws, a plurality of clamping guides being provided in the case of centrically arranged clamping jaws. A clamping receptacle is preferably formed between the clamping elements.

The inclined measuring surface is preferably designed to be continuously flat. The inclined measuring surface can run along a straight plane or a curved plane. If the inclined measuring surface runs along a curved plane, the angle is determined on the basis of an auxiliary straight line through the measuring ends along the clamping direction. It is advantageous if a greater slope of the inclined measuring surface is provided in the corresponding critical position range of the clamping element, in particular in the region of the stop of the clamping element. It is also conceivable that the inclined measuring surface is not designed to be continuous but provides steps, wherein the angle relative to the clamping direction is formed across the steps.

When the clamping element is moved along the clamping direction, the position sensor detects a changing distance from the inclined measuring surface. The distance between the position sensor and the inclined measuring surface can increase or decrease toward the clamping receptacle. In the case of a plurality of inclined measuring surfaces on one clamping element, it is conceivable that one inclined measuring surface increases toward the clamping receptacle and one inclined measuring surface decreases toward the clamping receptacle so that higher reliability in the position detection can be achieved. In addition, one position sensor per clamping element is preferably provided. The position sensor preferably comprises an evaluation unit which has a memory and provides the correlation between the detected distance and the position of the clamping element. The position of the clamping element can consequently be directly determined on the basis of the detected distance.

Advantageously, the inclined measuring surface has a measuring length running parallel to the clamping direction. The measuring length is located in at least one plane of the clamping guide. The measuring length preferably runs parallel to the clamping direction between the two measuring ends. In addition, the clamping element has a clamping element length running parallel to the clamping direction. The clamping element preferably has a front side arranged perpendicularly to the clamping direction and a rear side arranged perpendicularly to the clamping direction and opposite the front side. The clamping element length runs between the front side and the rear side of the clamping element. It is advantageous if the ratio between the measuring length and the clamping element length is equal to or less than 1:1 and/or equal to or more than 1:10, in particular between 1:2 and 1:6. It is also advantageous if the inclined measuring surface, in particular its measuring length, is designed such that the inclined measuring surface interacts with the assigned position sensor over the entire stroke of the clamping element in that the sensor axis of the position sensor and the inclined measuring surface in particular intersect.

It is also advantageous if the inclined measuring surface has a measuring height running perpendicularly to the clamping direction and parallel to the front side of the clamping element. In addition, the clamping element has a clamping element height running perpendicularly to the clamping direction and parallel to the front side. The clamping element preferably has an upper side arranged parallel to the clamping direction and an underside arranged parallel to the clamping direction and opposite the upper side. The clamping element height runs between the upper side and the underside of the clamping element. It is advantageous if the ratio between the measuring height and the clamping element height is equal to or less than 1:1 and/or equal to or more than 1:20, in particular between 1:2 and 1:10.

An advantageous development provides at least one inlay on the at least one inclined measuring surface. The inlay is provided for preventing material accumulation on the inclined measuring surface. During operation of the clamping or gripping device, metallic abraded material can be produced between the clamping 20 element and the clamping guide and can accumulate on the inclined measuring surface. This abraded material negatively influences the result of the position detection. Other contaminants can also deposit on the inclined measuring surface. The inlay prevents contaminants that significantly disturb the measurement result from being able to reach the inclined measuring surface. The inlay preferably realizes lifetime lubrication of the clamping element and/or of the clamping guide. The inlay can only be placed against the inclined measuring surface and is then held on the inclined measuring surface by the clamping guide. It is also conceivable for the inlay to be glued to the inclined measuring surface or to be connected to, in particular cast into, the clamping element in another way. It is conceivable, for example, that the clamping element is designed in one piece with the inlay, wherein the region of the inlay is produced differently from the remaining clamping element.

The material of the inlay depends on the type of the position sensor. The material must be selected such that the position sensor can still detect the distance between the position sensor and the inclined measuring surface through the inlay. If the position sensor is designed as an inductive sensor, it is advantageous if the inlay is made of a non-metallic material. The measurement signal of the position sensor is thus not decisively influenced by the inlay.

Advantageously, the outer contour of the inlay substantially corresponds to the portion of the clamping element that was removed or omitted to form the inclined measuring surface. Consequently, the clamping element can be reliably guided in the clamping guide even with an inclined measuring surface and an inlay.

A further advantageous embodiment provides that the clamping element has two jaw sides arranged parallel to the clamping direction and perpendicularly to the front side. The inclined measuring surface is preferably arranged in or on one of the jaw sides. When gripping or clamping components, tilting of the clamping element may occur, wherein the clamping element tilts about a tilting axis, which runs perpendicularly to the jaw side. Due to the arrangement of the inclined measuring surface on a jaw side, when the clamping element is tilted about the tilting axis, the distance between the position sensor and the inclined measuring surface does not change so that a higher measurement reliability can thus be achieved. In contrast, if the inclined measuring surface is arranged on the underside or the upper side of the clamping element, the distance would change when the clamping element is tilted about the tilting axis. In order to reduce the measurement uncertainty caused by the tilting of the clamping element, a respective inclined measuring surface can be arranged in or on the jaw side and in or on the underside. Alternatively or additionally, at least one inclined measuring surface can be arranged in or on the housing, in particular in or on the clamping guide, and at least one position sensor can be arranged on at least one clamping element.

A long-lasting development of the invention provides that the clamping guide is designed as a groove guide. It is advantageous if the clamping guide has at least one guide web and/or at least one guide groove. In addition, it is advantageous if the clamping element has at least one jaw web and/or at least one jaw groove and if the guide web and the jaw groove and/or the jaw web and the guide groove interact. Such a groove guide has the advantage that the guide can be loaded more heavily and higher forces and torques can be absorbed as a result.

Advantageously, at least one inclined measuring surface is arranged on the at least one jaw web and/or jaw groove of the clamping element so that the inclined measuring surface can be detected easily by the position sensor. Furthermore, the inlay arranged on the inclined measuring surface is preferably integrally formed on the inclined measuring surface on the clamping element side and is integrally formed on the groove guide, in particular on the guide groove and/or the guide web, on the guide side. The jaw web and/or the jaw groove with the inclined measuring surface consequently comprises a clamping element portion and an inlay portion. It is also conceivable that the inclined measuring surface extends across more than one jaw web and/or one jaw groove. Reliable guidance of the clamping element can thus be ensured even with an inclined measuring surface and/or an inlay.

A recess is preferably provided on the clamping element, in particular if the clamping guide is designed as a T-groove or the inclined measuring surface is arranged on a jaw groove or a flat portion of the clamping element, wherein at least one inclined measuring surface is provided in the recess. The recess is preferably designed as a cuboid or is introduced as a groove into the clamping element, wherein the groove depth changes linearly along the clamping direction to form the inclined measuring surface. The inclined measuring surface preferably forms the bottom of the recess or of the groove. The distance between the position sensor and the inclined measuring surface increases with the groove depth. If the inclined measuring surface is provided on a raised, protruding portion of the clamping element, the inclined measuring surface is advantageously to be designed without a recess.

The position sensor preferably extends along a sensor axis which is arranged perpendicularly to the clamping direction and is arranged in particular perpendicularly to the jaw side of the clamping element. A compact clamping or gripping device can thus be provided, wherein the position sensor can additionally be arranged close to the clamping element.

The housing preferably has a sensor bore running perpendicularly to the clamping direction, in particular perpendicularly to the jaw side of the clamping element, wherein the position sensor is arranged in the sensor bore. The sensor bore preferably extends up to the clamping guide. Accordingly, a clamping or gripping device with a small interference contour can be provided.

At its free end facing the clamping element, the position sensor advantageously has a spacer sleeve. A position sensor can thus be used with different housing sizes and wall thicknesses in that only the spacer sleeve has to be adapted to the size of the sensor bore. It is conceivable for the spacer sleeve to be closed at the end facing the clamping element, so that no contaminants enter the sensor bore and/or reach the position sensor. It is also conceivable for the spacer sleeve to be produced from the preferably non-metallic material of the inlay so that reliable position detection is ensured.

At the end facing the clamping element, the spacer sleeve is advantageously integrally formed on the multi-groove guide or the at least one jaw web of the clamping element. For this purpose, the spacer sleeve has a web receptacle, wherein the jaw web engages in the spacer sleeve during operation. The spacer sleeve preferably touches the jaw web or the inlay on the upper side and/or on the underside.

It is also advantageous if the position sensor is designed as an inductive sensor and/or as a tactile sensor. In the case of an inductive sensor, it is advantageous that contact between the inclined measuring surface and the sensor is not necessary. If a tactile sensor is used, no inlay can be used between the position sensor and the inclined measuring surface.

Further details and advantageous embodiments of the invention can be found in the following description, on the basis of which an embodiment is described and explained in more detail. In the drawings:

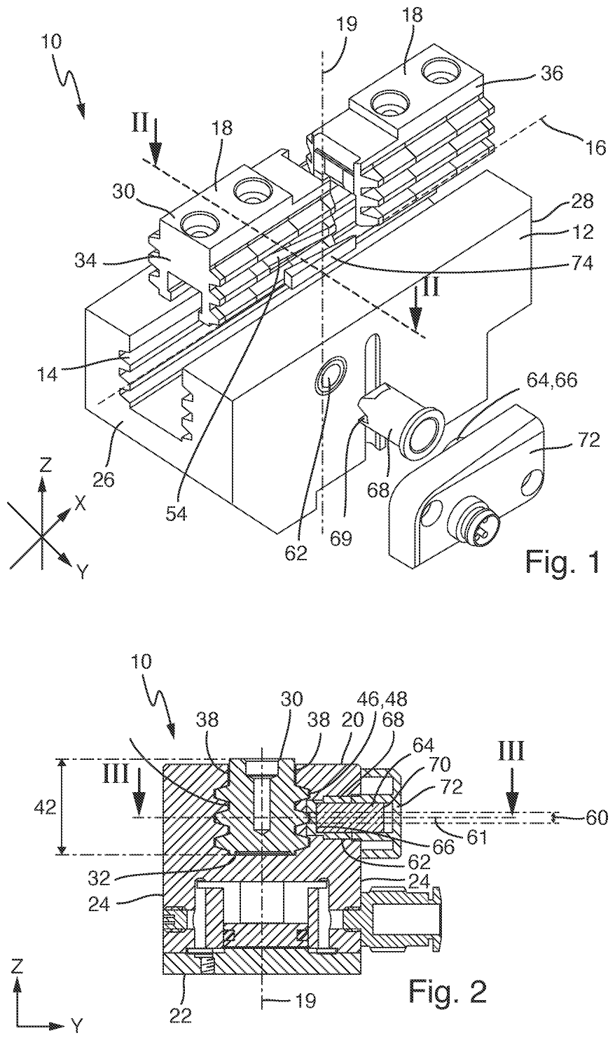

FIG. 1 is a view of a clamping module with a clamping element comprising an inclined measuring surface;

FIG. 2 is a sectional view of the clamping module according to section II-II of FIG. 1; and

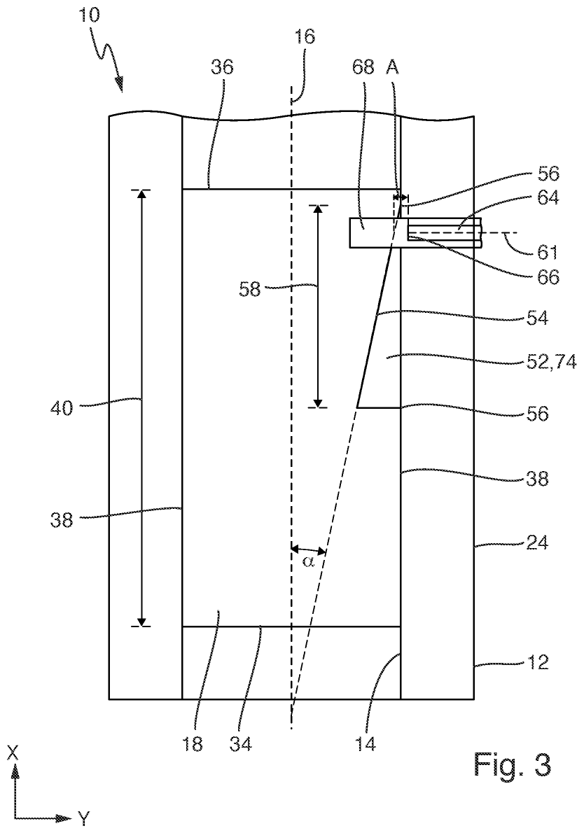

FIG. 3 is a sectional view of the clamping module according to section III-III of FIG. 2.

FIGS. 1 to 3 show a clamping or gripping device 10 in the form of a parallel gripper for gripping components. FIG. 1 shows the parallel gripper in an exploded view. The clamping or gripping device 10 comprises a housing 12 with a clamping guide 14 arranged in the housing 12. Two clamping elements 18 in the form of gripping jaws, which can be moved along a clamping direction 16, are arranged in the clamping guide 14. Gripping fingers for gripping components can be arranged on the gripping jaws. Such a component can be gripped both internally between the clamping elements 18 and externally outside the clamping elements 18.

Alternatively, the clamping or gripping device 10 can, for example, be designed as a zero-point clamping module with a clamping receptacle for receiving a clamping bolt, wherein the clamping bolt can be inserted into the clamping receptacle along a central longitudinal axis 19. At least two clamping elements 18, which are designed as clamping slides, can be provided for fixing the clamping bolt.

FIGS. 1 to 3 show a coordinate system, wherein the X-axis runs parallel to the clamping direction 16, the Z-axis runs parallel to the central longitudinal axis 19, and the Y-axis runs perpendicularly to the X-axis and the Z-axis.

The housing 12 comprises a housing upper side 20 assigned to the clamping elements 18 and running parallel to the clamping direction 16, a housing underside 22 facing away from the housing upper side 20 and running parallel to the clamping direction 16, and two housing outer sides 24 running parallel to the clamping direction 16. In addition, the housing 12 has a housing front side 26 running perpendicularly to the clamping direction 16 and a housing rear side 28 facing away from the housing front side 26 and running perpendicularly to the clamping direction 16. The clamping guide 14 extends in the housing 12 between the housing front side 26 and the housing rear side 28. The clamping elements 18 can thus be moved toward and away from one another at least between the housing front side 26 and the housing rear side 28.

The clamping elements 18 each have an upper side 30 assigned to the housing upper side 20, an underside 32 assigned to the housing underside 22, a front side 34 assigned to the housing front side 26, a rear side 36 assigned to the housing rear side 28. In addition, the clamping elements 18 each comprise two jaw sides 38 assigned to the clamping guide 14. According to FIG. 3, the clamping element 18 has a clamping element length 40, which runs parallel to the clamping direction 16 and extends between the front side 34 and the rear side 36, and, according to FIG. 2, it has a clamping element height 42, which runs perpendicularly to the clamping direction 16 and parallel to the jaw side 38 and extends between the upper side 30 and the underside 32.

It can be seen in FIG. 2 that the clamping guide 14 is designed as a multi-groove guide and has two guide webs 44 running parallel to the clamping direction 16 and three guide grooves 46 running parallel to the clamping direction 16, wherein the guide webs 44 and the guide grooves 46 are arranged alternately along the central longitudinal axis 19. Along the clamping direction 16, the clamping elements 18 have an outer contour corresponding to the clamping guide 14, wherein the clamping elements 18 each have three jaw webs 48 running parallel to the clamping direction 16 and two jaw grooves 50 running parallel to the clamping direction 16. During operation, the jaw webs 48 engage in the guide grooves 46 and the guide webs 44 engage in the jaw grooves 50. Alternatively, the clamping guide 14 can also be designed as a T-groove, wherein the clamping elements 18 then have a corresponding T-shaped design.

FIGS. 1 and 3 show that one of the clamping elements 18 has an inclined measuring surface 54, which is arranged in one of the jaw side 38. The inclined measuring surface 54 is provided in the central jaw web 48 and extends along the clamping direction 16. The inclined measuring surface 54 can alternatively extend across a jaw web 48 and a jaw groove 50 or across a plurality of jaw webs 48. It is conceivable that a plurality of inclined measuring surfaces 54 are provided along the clamping direction 16 and/or along the central longitudinal axis 19.

The inclined measuring surface 54 is introduced by material removal along the clamping direction 16, wherein more material is removed linearly as the distance from the central longitudinal axis 19 increases. Alternatively, the material removal can decrease as the distance from the central longitudinal axis 19 increases. Due to the material removal changing along the clamping direction 16, the inclined measuring surface 54 and the clamping direction 16 enclose an angle α, which is approximately 15°. The angle α can also preferably be more than 0° and less than 90°, preferably between 1° and 40°, and preferably between 2° and 15°. The inclined measuring surface 54 extends between a measuring end 56 facing the central longitudinal axis 19 and a measuring end 56 facing away from the central longitudinal axis 19. It is conceivable that the material removal at one measuring end 56 is equal to 0, or that the material removal at both measuring ends 56 is more than 0.

According to FIG. 3, the inclined measuring surface 54 can be provided at a recess 52. The recess 52 can be introduced as a groove into the clamping element 18, wherein the inclined measuring surface 54 is formed by a groove depth changing along the clamping direction 16.

According to FIG. 3, the inclined measuring surface 54 has a measuring length 58, which runs parallel to the clamping direction 16 and extends between the two measuring ends 56. Furthermore, the inclined measuring surface 54 according to FIG. 2 has a measuring height 60 running perpendicularly to the clamping direction 16 and parallel to the jaw side 38. The ratio between the measuring length 58 and the clamping element length 40 is approximately 1:2. The ratio is preferably equal to or less than 1:1 and/or equal to or more than 1:10, in particular equal to or less than 1:2 and/or equal to or more than 1:6. The ratio between the measuring height 60 and the clamping element height 42 is 1:8. The ratio is preferably equal to or less than 1:1 and/or equal to or more than 1:20, in particular equal to or less than 1:2 and/or equal to or more than 1:10.

According to FIGS. 2 and 3, at least one sensor bore 62, running parallel to the Y-axis and along a sensor axis 61, for receiving a position sensor 64 is provided in the housing outer side 24 of the housing 12. The position sensor 64 is designed as an inductive sensor. In the sensor bore 62, the position sensor 64 can be arranged such that it is aimed directly at the clamping element 18.

At its free end 66, the position sensor 64 can be introduced with a spacer sleeve 68 into the sensor bore 62. The spacer sleeve 68 protects the position sensor 64 from contaminants, adhering materials, and abraded material. In addition, the spacer sleeve 68 is closed on the guide side so that no contaminants penetrate into the sensor bore 62. The position sensor 64 can be used in differently dimensioned housings 12 and wall thicknesses in that only the spacer sleeve 68 has to be adapted to the housing size. FIG. 2 shows that the position sensor 64 partially engages in the spacer sleeve 68 and extends into the region of the clamping element 18. However, the position sensor 64 is not in direct contact with the clamping element 18. The spacer sleeve 68 is designed such that portions of the spacer sleeve 68 are arranged between the position sensor 64 and the clamping element 18. Furthermore, the spacer sleeve 68 is integrally formed on the guide side on the guide groove 46 and/or on the guide webs 44 with a web receptacle 69 so that the jaw web 48 of the clamping element 18 engages in portions in the spacer sleeve 68. Consequently, the guide web 44 and/or the guide groove 46 is formed in portions by the clamping guide 14 and in portions by the spacer sleeve 68.

According to FIG. 1, on the side 70 facing away from the clamping element 18, the position sensor 64 is arranged in an evaluation device 72, wherein the evaluation device 72 is arranged on a housing outer side 24. The evaluation device 72 comprises a computing unit with a memory.

The clamping element 18 and the inclined measuring surface 54 are designed in such a way that, when the clamping element 18 is moved along the clamping direction 16, the position sensor 64 is always aimed at the inclined measuring surface 54. Accordingly, the measuring length 58 represents the maximum stroke of the clamping element 18. The position sensor 64 detects the distance A running parallel to the Y-axis between the position sensor 64 and the inclined measuring surface 54. Each position of the clamping element 18 has a characterizing distance A, wherein the position of the clamping element 18 is anti-/proportional to the distance A. If the clamping element 18 is moved upward according to FIG. 3, the distance A increases due to the angled inclined measuring surface 54. The evaluation device 72 provides a data set, in which the distance A is assigned to the corresponding position of the clamping element 18. The position of the clamping element 18 and/or the distance A is provided by the measuring device 72 by means of a data connection and/or via radio. Consequently, a clamping or gripping device 10 with a position detection of the clamping element 18 results, which device has little installation effort and a small interference contour and at the same time enables continuous position detection as well as high measurement and repeat accuracy.

The arrangement of the inclined measuring surface 54 on one of the jaw sides 38 of the clamping element 18 makes it possible to reliably detect the position of the clamping element 18, even if the clamping element 18 should tilt about the Y-axis during operation. It is also conceivable that one or more inclined measuring surfaces 54 are provided per clamping element 18. The inclined measuring surfaces 54 can then provide different angles α relative to the clamping direction 16; in particular, one inclined measuring surface 54 can enclose a positive angle α, for example 30°, and a further inclined measuring surface on the same clamping element 18 can enclose a negative angle α, for example −30°, with the clamping direction 16. Thus, even if the clamping element 18 is tilted about the X-axis, the position of the clamping element can be reliably detected.

At least one inlay 74 is preferably arranged on the inclined measuring surface according to FIG. 3. The inlay 74 is provided for preventing material accumulation on the inclined measuring surface 54. During operation of the clamping or gripping device 10, abraded material can be produced between the clamping element 18 and the clamping guide 20, which abraded material can deposit on the inclined measuring surface 54. This abraded material negatively influences the result of the position detection. Other contaminants can also deposit on the inclined measuring surface 54. The inlay 74 prevents contaminants that significantly disturb the measurement result from being able to deposit on the inclined measuring surface 54. The inlay 74 is integrally formed on the inclined measuring surface 54 on the clamping element side and on the jaw web 48 on the guide side so that the jaw web 48 of the clamping element 18 is formed in portions by the clamping element 18 and in portions by the inlay 74.

The inlay 74 can be placed against the inclined measuring surface 54 and is held on the inclined measuring surface 54 by the clamping guide 20. It is also conceivable that the inlay 74 is glued to the inclined measuring surface 54 or connected in another way to the clamping element 18. The inlay 74 consists of a material which does not significantly influence the measurement result of the position sensor 64. In this case, the clamping element 18 is metallic and the position sensor 64 is designed as an inductive sensor so that the inlay 74 is preferably non-metallic. Preferably, the spacer sleeve 68 is formed from the same material or another non-metallic material so that the spacer sleeve 68 does not significantly disturb the measurement result of the position sensor 64.

1-15. (canceled)

16. A clamping or gripping device (10) comprising a housing (12), a clamping guide (14) which is arranged in the housing (12), at least one clamping element (18) which can be moved in the clamping guide (14) along a clamping direction (16), and at least one position sensor (64) for detecting the position of the clamping element (18), wherein the clamping element (18) has an upper side (30) extending parallel to the clamping direction (16), an underside (32) opposite the upper side (30) and extending parallel to the clamping direction (16), and two jaw sides (38) each extending between the upper side (30) and the underside (32) and running parallel to the clamping direction (16), wherein at least one inclined measuring surface (54) is provided in or on at least one clamping element (18), wherein the inclined measuring surface (54) is arranged at an angle (α) of more than 0° and/or less than 90°, in particular between 1° and 40°, preferably between 2° and 15°, relative to the clamping direction (16), and
the at least one position sensor (64) is designed such that the position sensor detects the position of the at least one clamping element (18) along the clamping guide (14) on the basis of the distance (A) between the at least one position sensor (64) and the at least one inclined measuring surface (54), said distance running perpendicularly to the clamping direction (16), characterized in that the at least one inclined measuring surface (54) is arranged in or on at least one of the jaw sides (38),
in that the housing (12) has an housing outer side (24),
in that a sensor bore (62) extending parallel to the upper side (30) along a sensor axis (61) is provided in the housing outer side, and
in that the at least one position sensor (64) is arranged in the sensor bore (62) along the sensor axis (61).

17. The clamping or gripping device (10) according to claim 16, wherein at least one inclined measuring surface (54) has a measuring length (58) running parallel to the clamping direction (16), wherein the at least one clamping element (18) has a clamping element length (40) running parallel to the clamping direction (16), and wherein the ratio between the measuring length (58) and the clamping element length (40) is in a range between 1:1 and 1:10.

18. The clamping or gripping device (10) according to claim 16, wherein at least one inclined measuring surface (54) has a measuring height (60) running perpendicularly to the clamping direction (16), wherein the at least one clamping element (18) has a clamping element height (42) running perpendicularly to the clamping direction (16), and wherein the ratio between the measuring height (60) and the clamping element height (42) is in a range between 1:1 and 1:20.

19. The clamping or gripping device (10) according to claim 16, wherein, for preventing material accumulation on at least one inclined measuring surface (54), at least one inlay (74) is arranged on at least one inclined measuring surface (54).

20. The clamping or gripping device (10) according to claim 19, wherein the at least one inlay (74) consists of a non-metallic material so that the measurement signal of the position sensor (64) is not decisively influenced by the inlay (74).

21. The clamping or gripping device (10) according to claim 19, wherein the outer contour of the inlay (74) substantially corresponds to the portion of the clamping element (18) that was removed or omitted to form the inclined measuring surface (54).

22. The clamping or gripping device (10) according to claim 16, wherein the clamping guide (14) has at least one guide web (44) and/or at least one guide groove (46), wherein at least one clamping element (18) has at least one jaw web (48) and/or at least one jaw groove (50), and wherein the guide web (44) engages in the jaw groove (50) or the jaw web (48) engages in the guide groove (46).

23. The clamping or gripping device (10) according to claim 22, wherein at least one inclined measuring surface (54) is arranged in or on the at least one jaw web (48) and/or the at least one jaw groove (50).

24. The clamping or gripping device (10) according to claim 16, wherein the at least one clamping element (18) has at least one recess (52), in which the inclined measuring surface (54) is provided.

25. The clamping or gripping device (10) according to claim 16, wherein, at its free end (66) facing the at least one clamping element (18), the at least one position sensor (64) has a spacer sleeve (68).

26. The clamping or gripping device (10) according to claim 22, wherein, at the end (66) facing the clamping element (18), the spacer sleeve (68) has a web receptacle (69) for receiving the at least one jaw web (48) of the clamping element (18) so that the jaw web (48) engages in the spacer sleeve (68) during operation.

27. The clamping or gripping device (10) according to claim 16, wherein at least one position sensor (64) is designed as an inductive sensor.
